(19) United States
(12) Patent Application Publication
(10) Pub. No.: US 2008/0202005 A1
(43) Pub. Date: Aug. 28, 2008

(54) DECORATIVE DECAL SYSTEM ON LOUVERED BLINDS

(76) Inventors: Jie Floyd, Bethlehem, PA (US); Robert J. Floyd, Bethlehem, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/679,586

(22) Filed: Feb. 27, 2007

(51) Int. Cl. G09F 7/12

(52) U.S. Cl. 40/594; 160/236

(57) ABSTRACT

This invention relates to a decorative decal system for louvered devices, wherein louvers rotate in unison between a full open-to-view position to a full closed-to-view position. A set of pre-cut decal strips of flexible sheet material is provided, each including a front surface having a decorative design segment imprinted thereon and a back surface having an adhesive layer applied thereon. When the strips are attached to the louvers, the design segments provide the appearance of a continuous unitary pattern when the louvers are in the full closed-to-view position. Each decal strip includes a back support strip peelable therefrom to assist in alignment and to permit the decal strip to be attached to a louver. A single front cover sheet is provided for maintaining proper alignment of the decal strips during attachment to the louvers.

### FIELD OF THE INVENTION

This invention relates generally to a decorative decal system for louvered devices such as venetian blinds or mini-blinds and more specifically relates to a series of adhesive backed decal strips for application to louvered blinds.

### BACKGROUND OF INVENTION

Heretofore, it has been found cumbersome to put decals including designs and graphics on louvered devices formed by slats or louvers. In the past this has been attempted by painting, printing and the like, none of which has been commercially expedient for a multitude of reasons.

It is now proposed to accomplish this with a decorative decal system as described herein which includes adhesive-backed decal strips for applying to the louvers. Back support strips are provided which are peelable from the decal strips just prior to applying the decal strips. The back support strips also provide alignment capability during application of the decal strips. A front cover sheet is also provided for maintaining proper alignment of the remaining decal strips to be applied to the louvers.

### SUMMARY OF THE INVENTION

This invention relates to a decorative decal system for louvered devices. Such louvered devices typically include a plurality of elongated louvers supported in a substantially parallel relationship to each other. Each louver rotates in unison between a full open-to-view position to a full closed-to-view position. Each louver has a width, a height, and a marginal edge. The marginal edge overlaps a marginal edge of the next adjacent louver, thus providing a hidden portion on the next adjacent louver when the louvers are in the closed-to-view position. The remainder of each next adjacent louver includes a visible portion. A set of pre-cut elongated strips of flexible sheet material is provided. Each strip extends at least a portion of the width of each louver and is of sufficient height to cover at least the visible portion of the louver to which it is applied while the louvers are in the full closed-to-view position. Each decal strip includes a front surface having a decorative design segment imprinted thereon and a back surface having an adhesive layer applied thereon. When the strips are attached to the louvers, the design segments provide the appearance of a continuous unitary pattern when the louvers are in the full closed-to-view position. When the louvers are in the full open-to-view position, the decorative strips to not block obstruct the view therethrough.

A removable back support strip, substantially of the same width and height as each decal strip, is adhered to the adhesive layer of each decal strip until it is peeled therefrom to permit the decal strip to be attached to a louver. The removable back support strip also serves to assist in aligning a next adjacent decal strip during its attachment to a louver. A single front cover sheet having the approximate dimensions of the continuous unitary pattern is provided with means for adhering to the front surface of the decal strips. The front cover sheet is provided to maintain proper alignment of the decal strips during attachment to the louvers and is removable from the decal strips once each decal strip has been applied to the louver.

### BRIEF DESCRIPTION OF THE DRAWINGS

FIG. 1 is an elevational view of a louvered blind device illustrating the design elements of the decal strips of the present invention which provide an appearance of a continuous unitary pattern when the louvers are in the full closed-to-view position;

FIG. 2 is an elevational view of a louvered blind device in the open-to-view position;

FIG. 3 is an enlarged view of the decorative decal system of the present invention illustrating the decal strips, the back support strips and the top sheet;

FIG. 4 is an enlarged view of the decorative decal system of the present invention illustrating the manner of applying the decal strips to individual louvers of the louvered blind device; and,

FIG. 5 is an enlarged sectional view taken along 5-5 of FIG. 3.

### DETAILED DESCRIPTION OF THE INVENTION

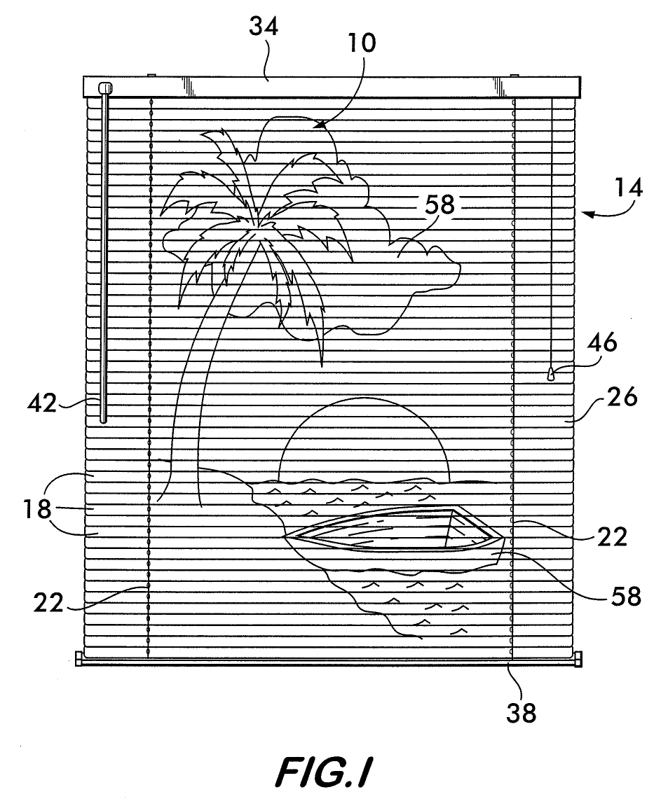

Referring now to the various figures wherein like reference characters refer to like parts, an embodiment of the decorative decal system of the present invention is generally shown at 10 in FIG. 1 applied to a louvered device 14 having a plurality of horizontally disposed elongated louvers 18 supported in substantially parallel relationship to each other. Each louver 18 is rotatable about a respective longitudinal axis of such louver wherein the louvers rotate in unison from a full open-to-view position to provide room darkening and privacy to a full open-to-view position to allow light into a room from outside. The louvered device 14 includes vertical cords 22 which hold the louvers 18 in parallel relationship to each other.

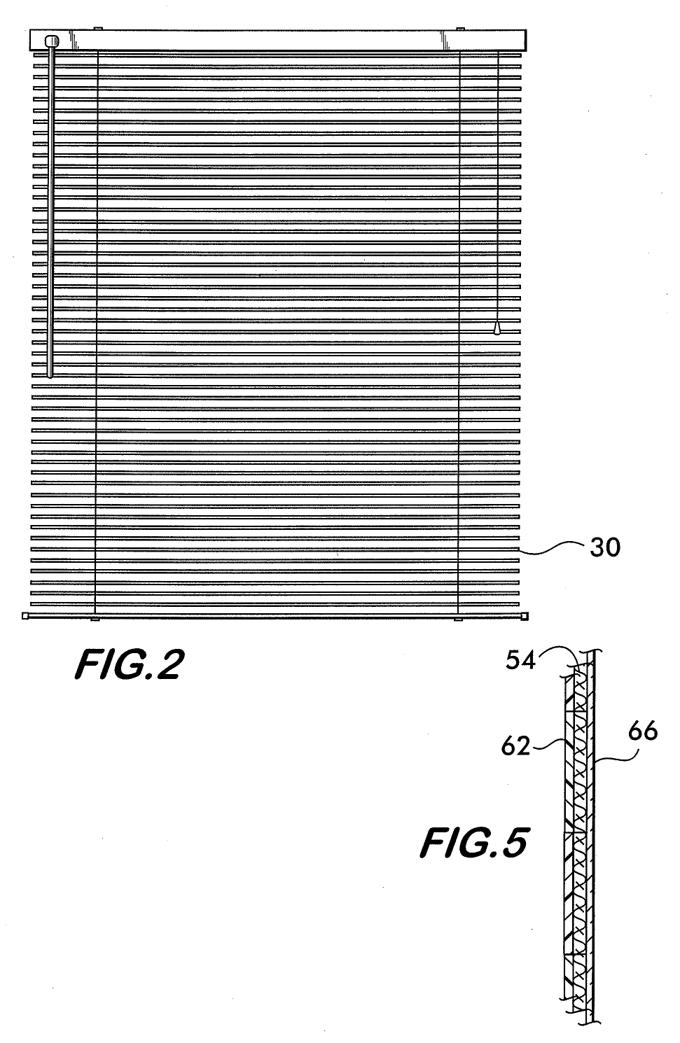

As shown in FIG. 1, each louver 18 includes a front face 26. Referring now to FIG. 4, each louver 18 has a width indicated by “W”, a height, a hidden portion indicated by “D1”, and a visible portion indicated by “D2” when in the full closed-to-view position. That is, the lower marginal portion of each louver 18 overlaps an upper marginal portion of the next adjacent louver 18, thus providing a hidden portion D1 on the next adjacent louver when the louvers are in the closed-to-view position. The remainder of each next adjacent louver includes a visible portion D2. Referring again to FIG. 1, as is conventional, the louvered device 14 includes a header or top rail 34, a bottom rail 38, a tilt wand 42 and lift cords 46, which function in their customary manner. A R1 of the louvers 18 from the top rail 34 to the bottom rail 38, are identical to one another. FIG. 2 is a view of the embodiment of FIG. 1 in the full open-to-view position wherein the bottom edge 30 of each louver 18 is apparent.

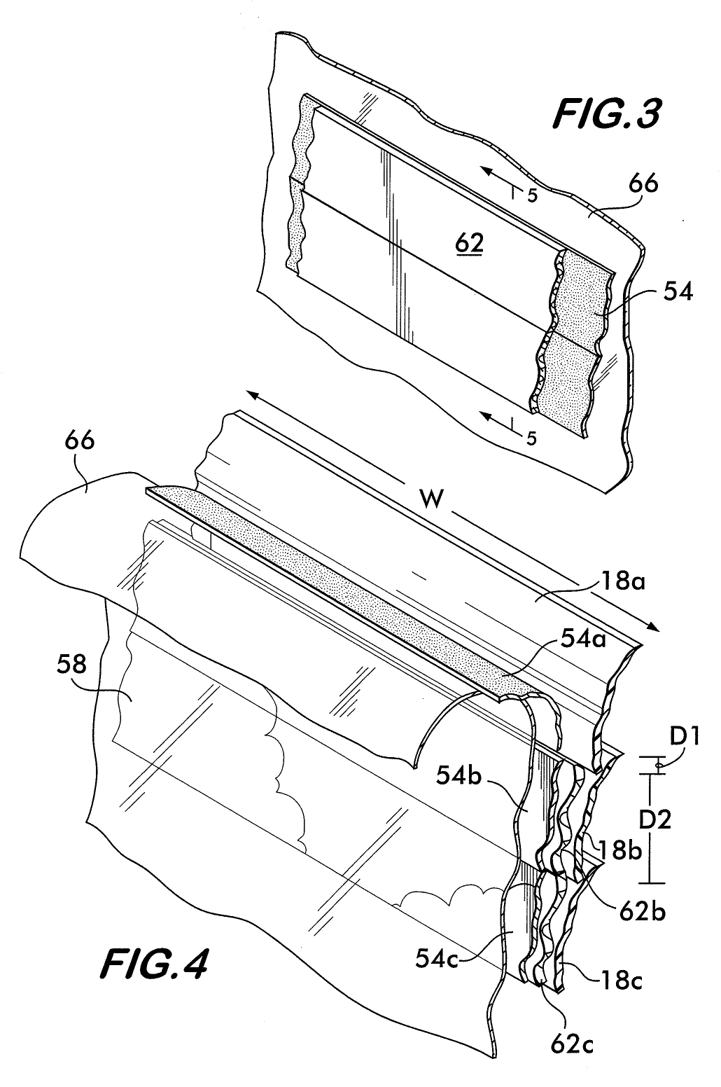

Referring now to FIGS. 3-5, the decal system 10 is comprised of a set of elongated decal strips 54 of flexible sheet material which are pre-cut. The decal strips 54 are preferably made of a flexible plastic sheet material such as vinyl film or other material with a suitable adhesive on the back surface which permits the decal to be applied to a louver 18 or other surface but later removed without leaving an adhesive residue. Each decal strip 54 includes a front surface having a decorative design element 58 (FIG. 4) disposed thereon such that when the decal strips 54 are attached to the louvers, in total, they provide the appearance of a continuous unitary pattern when the louvered device is in the full closed-to-view position.

Referring now to FIG. 5, each decal strip 54 is attached to a removable back support strip 62 by an adhesive layer (not shown). The back support strip 62 is of the same approximate width and height as the decal strip 54. The back support strip 62 can be made of any suitable material, and preferably is made of a thickened card stock that is somewhat rigid. The width of each decal strip 54 varies and extends at least a portion of the width of each louver 18. In many typical devices having louvers 18 of a certain height, the decal strips 54 need not cover the entire height of a louver 18 but should be high enough to extend the distance of the visible portion D2 of the louver 18 beneath the overlap of the next adjacent louver. In this manner, the decal strip 54 is of a height which may, when used on some heights of louvers, terminate a short distance from the top edge of the louver when the louvered device 14 is in the full closed-to-view position.

It will be recognized that the height of the decal strips 54 can vary depending upon the height of the louvers 18, however the main criterion for determining the height of the decal strips is that the decorative pattern covers all the visible height D2 of the louver 18 so that the pattern is uninterrupted and forms a unitary design on the louvered device 14. For example, in a typical mini-blind, each louver is 1″ (2.54 cm) high and when the louvers 18 are closed, there would be 7/32″ (0.56 cm) overlap of each louver 18 over the next adjacent louver 18 and there would be 25/32″ (1.98 cm) height showing on the front surface of each louver 18 and therefore that same height of decal strip 54 would show when attached to the louver.

The back support strip 62 is arranged to be peeled from the decal strip 54 just prior to applying the decal strip 54 to the louver 18. As the back support strip 62 is somewhat thickened and rigid, it is also used as an alignment tool for positioning the next adjacent decal strip 54 prior to applying it to the louver.

The decal strips 54 are covered by a top sheet 66 of paper or other suitable material having an adhesive layer (not shown) which permits easy removal from the top surface of the decal strip 54 without adhesive residue. Alternatively, the top sheet 66 could be adhered to the decal strips 54 by means of static cling. The top sheet 66 is preferably transparent or translucent to permit a decorative design element 58 to show through the top sheet 66 to aid in properly positioning it each strip in a desired location on a louver so that all the assembled decal strips 54 when mounted on a series of louvers 18 will form a decorative pattern in the desired location on a blind or other louvered structure.

In FIG. 4, three typical decal strips, i.e., an upper decal strip 54a, a middle decal strip 54b and a lower decal strip 54c, are shown adjacent to each other and in proximity to three typical adjacent louvers 18a, 18b and 18c, oriented in the full closed-to-view position. The upper decal strip 54a is shown adhered to the top sheet 66, but with its back support strip peeled away revealing the adhesive coated back surface of the decal strip 54a. The middle decal strip 54b is shown with its back support strip 62b in place. As mentioned previously, the back support strips 62 are somewhat thickened and rigid. In FIG. 4, the lower edge of the upper louver 18a is shown resting upon the upper edge of the middle back support strip 62b. In this manner, the back support strips 62 are used to align the decal strips 54 with the louver 18 just prior to application of the decal strips 54 to the louver 18. The top cover sheet 66 remains adhered to the decal strip 54a as the decal strip 54a is applied to the louver 18a. The top sheet 66 retains the decal strips 54 in proper alignment during application to the louvers 18. Once the decal strip 54a has been applied to the louver 18, the top sheet is peeled from the decal strip 54a. As shown in FIG. 4, each decal strip 54 is applied to the louvers in a certain sequence, e.g., top to bottom.

Once the decal strip 54a has been applied to louver 18a, the top sheet 66 is pulled back to reveal a portion of the decorative design element 58. Next, the back support strip 62b is removed from the middle decal strip 54b and the manner for aligning and applying the decal strip 54b is repeated until all decal strips 54 have been applied to the louvers 18. FIG. 5 shows the back support strip 62 mounted to the decal strip 54 and the translucent or transparent top sheet 66 covering the top surface of the decal strip 54.

FIG. 1 shows the appearance of the decal strips 54 mounted to the louvers 18 of the louvered device 14 with the back support strip 62 and the top cover sheet 66 removed. While this decal system is primarily designed for use on louvers which can be opened or closed, it can also be applied to a fixed louver assembly. Additionally, although the decal system of the present invention is shown arranged for use on a horizontal louvered device, it may be used for a louvered device having vertical louvers. These and various other modifications can be made herein without departing from the scope of the invention.

What is claimed:

1. A decorative decal system for louvered devices having a plurality of elongated louvers supported in substantially parallel relationship to each other and each louver being rotatable about a respective longitudinal axis of such louver wherein said louvers rotate in unison between a full open-to-view position to a full closed-to-view position, each said louver having a width, a height, and a marginal edge, the marginal edge of each of said louvers overlapping a marginal edge of the next adjacent louver, thereby providing a hidden portion and a visible portion on the next adjacent louver when the louvers are in the closed-to-view position, the system comprising:
a. a set of pre-cut decal strips of flexible sheet material, each strip extending at least a portion of the width of each louver and being of sufficient height to cover at least the visible portion of a louver to which it is applied while the louvered device is in the full closed-to-view position, each decal strip having a front surface including a decorative design segment imprinted thereon and a back surface having an adhesive layer applied thereon;
b. the design segments of the strips, when attached to the louvers, providing the appearance of a continuous unitary pattern when the louvered device is in the full closed-to-view position;
c. a removable back support strip of substantially the same height and width as each decal strip, said back support strip being adhered to the adhesive layer of each decal strip until it is peeled therefrom to permit the decal strip to be attached to a louver, the removable back support strip also serving to assist in aligning a next adjacent decal strip during its attachment to a louver; and,
d. a single top sheet having the approximate dimensions of the continuous unitary pattern and having means for adhering to the front surface of said decal strips, said top sheet maintaining proper alignment of said decal strips during attachment to the louvers, said top sheet being removable from each decal strip once the decal strip is applied to the louver.

2. The decorative decal system of claim 1 wherein said top sheet sheet is transparent.

3. The decorative decal system of claim 1 wherein said top sheet is substantially opaque.

4. The decorative decal system of claim 1 wherein said decal strips are comprised of a vinyl film.

5. The decorative decal system of claim 1 wherein said top sheet adheres to said decal strips by use of static cling.

6. The decorative decal system of claim 1 wherein the adhesive surface of said decal strips is such that the decal strip may be removed from the louver without leaving an adhesive residue.

7. The decorative decal system of claim 1 wherein said plurality of elongated louvers are horizontally oriented.

8. The decorative decal system of claim 1 wherein said plurality of elongated louvers are vertically oriented.

9. The decorative decal system of claim 1 wherein said removable back support strip is comprised of thickend card paper.

10. The decorative decal system of claim 1 wherein said adhesive layer of each decal strip is non-permanent and reusable which permits detachment of the decal strip from the louver.

11. The decorative decal system of claim 1 wherein said decal strips are removable from the louver.

12. The decorative decal system of claim 1 wherein said decal strips are sized to cover a visible portion of the louvers.

13. The decorative decal system of claim 1 wherein said top sheet adheres to said decal strips by use of adhesive.

14. A method for decorating a louvered device, the louvered device having a plurality of elongated louvers supported in substantially parallel relationship to each other and each louver begin rotatable about a respective longitudinal axis of such louver wherein said louvers rotate in unison between open and closed positions, each said louver having a width, a height, and a marginal edge, the marginal edge of each of said louvers overlapping a marginal edge of the next adjacent louver, thereby providing a hidden portion and a visible portion on the next adjacent louver when the louvers are in the closed-to-view position, said method comprising:
a. providing a set of pre-cut decal strips of flexible sheet material, each strip extending at least a portion of the width of each louver and being of sufficient height to cover at least the visible portion of a louver to which it is applied when the louvered device is in the closed position, each decal strip having a front surface including a decorative design segment imprinted thereon and a back surface having an adhesive layer applied thereon;
b. providing a set of pre-cut removable back support strips of substantially the same height and width as each decal strip, said back support strips being adhered to the adhesive layer of each said decal strip;
c. adhering a single top sheet to the front surface of all said decal strips;
e. peeling a back support strip from an decal strip;
f. using the top edge of the next adjacent back support strip to align the decal strip with the louver to which it is to be applied;
g. applying the decal strip onto a louver; and,
h. removing the top sheet from the decal strip just applied to the louver;
i. following steps e through h until all decal strips have beeen applied to the louvers.
